(19) United States
(12) Patent Application Publication
(10) Pub. No.: US 2008/0304404 A1
(43) Pub. Date: Dec. 11, 2008

(54) ARCHITECTURE FOR OWA BASED TDD-OFDM SYSTEM

(76) Inventors: WEI LU, (US); Jianhong Hu, (US)

Correspondence Address: WEI LU, 1218 BUBB RD, CUPERTINO, CA, 95014, US

(21) Appl. No.: 11/759,132

(22) Filed: Jun. 6, 2007

(51) Int. Cl. H04Q 7/00

(52) U.S. Cl. 370/210

(57) ABSTRACT

As no single wireless standard can provide both broadband high-speed and seamless mobility for commercial wireless communications in terms of technology, cost, spectrum and performance, a new wireless convergence platform based on Open Wireless Architecture (OWA) has been disclosed, wherein the OWA-based TDD-OFDM is utilized as the principal air interface to provide cost-effective and spectrum-efficient broadband high-speed wireless transmissions, and converges with the second air interface, such as TDD-SCDMA or TDD-WCDMA based on OWA convergence platform to provide seamless mobile communications in order to support the future service-oriented wireless multimedia mobility infrastructure.

### FIELD OF THE DISCLOSURE

The present disclosure relates generally to wireless communications, and more particularly to the future converged wireless and mobile communications based on Open Wireless Architecture (OWA) convergence technology where a TDD-OFDM system provides a cost-effective and spectrum-efficient broadband high-speed wireless transmission as the principal air interface, and converges with second air interface, such as TDD-SCDMA or TDD-WCDMA, to provide seamless mobile communications based on OWA wireless convergence platform in delivering the future service-oriented wireless multimedia mobility infrastructure.

### BACKGROUND OF THE DISCLOSURE

In the wireless and mobile communications, two transmission duplex solutions are popularly used: FDD (frequency division duplex) and TDD (time division duplex). Traditionally, FDD is widely used due to its simple implementation by assigning separate frequency bands for transmitting and receiving. However, FDD consumes much spectrum, and generates interference problems between transmitter and receiver if both frequency bands are too close, and waste much spectrum if the uplink (wireless terminal to base-station) and downlink (base-station to wireless terminal) transmission traffics are unbalanced, such as mobile video broadcasting service and Internet web browsing services.

TDD is a more efficient duplex way in terms of spectrum utilization because TDD only utilizes one frequency band for both transmitting and receiving. Moreover, TDD can adjust the downlink and uplink transmission resources based on the specific service requirements in both links, hence it improves the radio resource management and the corresponding spectrum utilization. Basically, TDD supports asymmetric traffics in downlink and uplink channels, and improves the radio transmission performance.

However, TDD has its problems in mobile wireless communications:
1. TDD requires very important guard time (GT) between uplink and downlink transmissions, which makes the system expensive in implementation,
2. The TDD switch point (SP) between downlink data traffics and uplink data traffics are hard to manage when the service and link asymmetry requirements change,
3. TDD was originally designed for wireless local loop (WLL) or local area wireless access networks, and hard to be applied for mobile cellular communications because of its complexity and high cost in maintaining the GT and SP in the seamless mobile multipath propagation environment,
4. TDD network optimization is very expensive in the commercial mobile cellular communications because the service operators can make profits only after the TDD system capacity is over 70% (an example based on TDD-SCDMA by China Mobile) which is difficult for TDD seamless mobile networks.

Secondly, the wireless transmission modulations and access control schemes include TDMA (time division multiplex access), CDMA (code division multiplex access) and FDMA (frequency division multiplex access). OFDMA (or OFDM in general), which is orthogonal frequency division multiplex access, is one of the very good FDMA solution.

The future wireless and mobile communications require broadband high-data transmission in support of wireless multimedia information delivery in a more wide scope of applications. In the commercial mobile and wireless networks, CDMA is a very good access control and seamless mobility scheme, but not a good broadband and high-speed transmission (over 20 M bps for example) air interface or called RTT (radio transmission technology). TDMA can provide very high-speed wireless transmission, but the spectrum utilization efficiency is too low, for example, Wireless Mobile ATM (asynchronous transfer mode) can support up to 522 M bps, but consumes too much spectrum. OFDM is a very good broadband high data-rate RTT in terms of spectrum utilization efficiency and cost effectiveness. However, OFDM is not optimized for seamless mobile and cellular communications because of its degraded multi-layer synchronization guarantees in the situation of seamless mobile environment, though the slow mobility and local area mobility are acceptable in commercial wireless networks.

The main considerations of the future commercial mobile and wireless communication networks should comprise:
1. High spectrum utilization efficiency and dynamic spectrum access capability because the wireless spectrum is a very limited natural resource, and becomes much more and more expensive in the future,
2. Broadband high-speed transmission capability to support the wireless multimedia services,
3. Seamless mobility capability to have users access the information from anywhere, anytime and anyone,
4. Asymmetric and adaptive transmission capability in both uplink and downlink channels to support open service architecture of mobile communications,
5. Cost effective system platform for the commercial applications which means the business model and value chain are targeted for profits as the first consideration,

Based on the above analysis of different duplex schemes and modulation schemes, no single wireless RTT or air interface can meet all the above five requirements for the future commercial mobile and wireless communications.

Therefore, the future commercial wireless and mobile communications must be based on a new architecture to converge multiple RTTs or air interfaces onto one common broadband wireless system platform which is technically called “Open Wireless Architecture (OWA)”.

Similar to the personal computer system with Open Computer Architecture (OCA), OWA defines an open convergence platform so that different RTTs, such as OFDM, CDMA and TDMA, can work together as a whole to compliment each other in any optimal way to deliver the service-oriented transmission platform, rather than the standard-specific platform. Based on OWA architecture, two or three selected RTTs can fully meet all the five requirements for the future commercial mobile wireless communications.

### SUMMARY OF THE INVENTION

An object of the invention is to overcome at least some of the drawbacks relating to the compromise designs of prior art systems as discussed above.

As stated above, no single wireless standard or RTT (radio transmission technology) can manage to provide both spectrum efficient broadband high-speed transmission and seamless mobility with cost-effective system offerings for the future commercial mobile wireless communications. To solve this problem, a new system architecture called Open Wireless Architecture (OWA) is utilized to converge selected multiple RTTs into one common system platform and complement each other in any optimal way for providing the future broadband wireless and mobility communication networks.

Based on this OWA platform, defined by OWA BIOS (basic input/output system) and Framework, a principal air interface or RTT is selected to meet the basic transmission requirements for the future commercial mobile wireless communications. This principal RTT is TDD-OFDM, based on OWA convergence platform. The OWA-based TDD-OFDM has the following advantages:
1. Open convergence platform for easy integration of other TDD RTTs such as TDD-SCDMA (synchronized code division multiplex access) and TDD-WCDMA (wideband code division multiplex access),
2. High spectrum utilization rate and scalable bandwidth to support dynamic spectrum access control and future open spectrum management,
3. Flexible asymmetric transmission traffics of uplink (wireless terminal to base-station) and downlink (base-station to wireless terminal) in one spectrum band,
4. Robust transmission modulation against the multi-path fading and interference reduction,
5. High-speed radio transmission and broadband high data-rate information transmission,
6. Multiple diversity in both the frequency and space domain by utilizing space-time processing techniques such as MIMO (multiple input and multiple output) to provide exceptional transmission performance and optimized spectrum efficiency,
7. Cost-effective system development by using FFT (fast fourier transform) for OFDM implementation and OWA BIOS and Framework for OWA common convergence platform implementation,

However, in order to have TDD-OFDM to maintain a required GT (guard time) and select an optimal SP (switch point) for TDD operation, and secure a CP (cyclic prefix) or guard interval for each OFDM symbol, the seamless mobility capability of this TDD-OFDM system must be limited, though somehow local mobility is still acceptable in commercial wireless networks. Furthermore, with some limitation in seamless mobility from the whole wireless networks point of view, the TDD-OFDM network optimization becomes feasible and cost-effective which is very important for a commercial mobile wireless communications.

To compensate for the limitation of this seamless mobility of mobile communications, the OWA convergence platform facilitates easily integration with other TDD RTTs such as TDD-SCDMA and TDD-WCDMA in providing optimal mobility access control and seamless mobility functions for the aforementioned OWA-based TDD-OFDM system. In other words for example, by inserting the OWA-based TDD-SCDMA transceiver module card into the OWA-based TDD-OFDM system, the converged OWA-TDD, or called TDD-OWA, can meet all the requirements of future commercial mobile and wireless communication networks in delivering the broadband high-speed radio transmission, seamless mobile cellular communication and the increased spectrum utilization efficiency.

The another advantage of OWA-based TDD-OFDM system is that each system module is an open module defined by OWA BIOS and Framework which is extensible, upgradeable and removable, so that the TDD-OFDM system can continue its long-term evolution path for better system performance and better transmission performance.

Last, but not least, the OWA-based TDD-OFDM system can operate in any frequency band through the OWA Spectrum Scheduler and Optimizer (SSO) module which validates the spectrum sensing model, updates the real-time digital spectrum map, calculates the spectrum allocation model, schedules the dynamic spectrum access, determines the frequency reuse strategy and tests the spectrum management performance for the OWA wireless convergence networks.

In summary, the architecture for OWA based TDD-OFDM of the present invention is an innovative approach to construct the future broadband wireless and mobile communication platform which has never been proposed in the prior arts. While many prior arts have been involved in the TDD-CDMA development or OFDM development, there was no prior work being done on the TDD-OFDM system implementation. Furthermore, the new technology architecture of Open Wireless Architecture (OWA), proposed in 2001 by me, is becoming the leading wireless convergence platform to drive the future mobile wireless communication system development. The OWA based TDD-OFDM, as set forth above, provides an open and common convergence platform to integrate second or multiple TDD RTTs, such as TDD-SCDMA and TDD-WCDMA, into this principal TDD-OFDM system framework for the construction of the future truly service-oriented broadband wireless and mobile communication infrastructure.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

Having thus described the invention in general terms, reference will now be made to the accompanying drawings, which are not necessarily drawn to scale, and wherein:

FIG. 1 is the general TDD-OWA converged system architecture, supporting various TDD radio transmission technologies including, but not limited to, TDD-OFDMA, TDD-SCDMA and TDD-WCDMA.

FIG. 2 is the OWA-based open TDD-OFDM system architecture, comprising complete transmitter and receiver architecture based on OWA BIOS and Framework platform.

FIG. 3 is an exemplary radio frame structure for OWA-based open TDD-OFDM system, including the important TDD switch point optimizer controlled by the OWA BIOS and Framework, etc.

FIG. 4 is the OWA-based open radio resource management architecture, supporting multi-radio access environment.

FIG. 5 is an illustration of different asymmetry scenarios for OWA-based TDD-OFDM system, supporting the TDD switch point optimization.

Like reference numerals refer to like parts throughout the several views of the drawings.

### DESCRIPTION OF THE PREFERRED EMBODIMENT

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

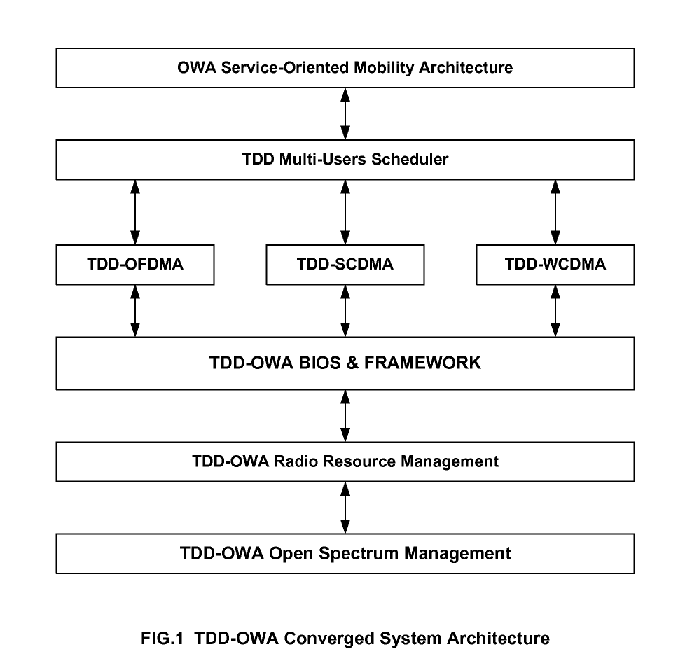

FIG. 1 illustrates a TDD-OWA (time division duplex—open wireless architecture) converged system architecture in which an embodiment of the present invention is implemented. Following the open interface definitions by TDD-OWA BIOS (basic input/output system) and framework, the system is fully supportive of open TDD air interfaces including, but not limited to, OFDMA (orthogonal frequency division multiplex access), SCDMA (synchronized code division multiplex access) and WCDMA (wideband code division multiplex access). In order to ensure an efficient use of available radio resources in different wireless access networks, an OWA based radio resource management subsystem is enforced to provide comparability, compatibility, conformance and optimization between various TDD air interfaces.

TDD is a preferred duplex solution for the future open spectrum allocation and dynamic spectrum access control because TDD only requires one spectrum band for both transmission and receiving in wireless communications. Spectrum is becoming an extremely limited nature resource in every country, and the spectrum sharing and dynamic spectrum allocation will be the only solution to enable the future wireless and mobile communication services and applications. TDD is optimized for such open and dynamic spectrum management.

OWA defines the open interfaces in wireless networks and systems, including baseband signal processing system, radio frequency (RF) system, networking, and service and application, so that the system can support different wireless industrial standards and integrate the various wireless networks into an open broadband platform. Like open computer architecture (OCA) in the computer systems, the OWA shares all the open system resources including hardware and software by mapping different wireless air interfaces to the open interface parameters of baseband, RF and networks. Each OWA system module is an open module, rather than any standard-specific module, and can be easily reconfigured to maximize the system performance, and minimize the spectrum utilization and power consumption. In addition, the OWA system is operable in any available spectrum band and capable of supporting spectrum recycling techniques in co-existence with current existing wireless communication technologies.

Another great benefit of TDD system is its downlink and uplink traffics can be dynamically asymmetric which is very important for future broadband wireless mobile communications. Combined with OFDM technology, each sub-carrier can support single user or multiple users subject to service-oriented criteria. Hence, the TDD Multi-Users Scheduler is responsible for coordinating difference users to access the multilayered channels provided by OFDMA, SCDMA or WCDMA radio transmission technologies.

The OWA Service-Oriented Mobility Architecture is to manage the open service delivery platform independent of the specific wireless standards, and manage the high-layer software architectures including, but not limited to, the multimedia framework, mobile operating systems, mobile applications, service convergence and security sublayer.

This TDD-OWA system architecture is very important because it provides a common and open platform for inter-compatibility among different TDD air interfaces including, but not limited to, OFDMA, SCDMA and WCDMA as well as other wireless access standards.

OWA will eventually become the global industry leading solution to integrate various wireless air interfaces into one wireless open terminal or system where the same end equipment can flexibly work in the wireless access domain as well as in mobile cellular networks. As no single wireless standard can compromise both broadband high data-rate and seamless mobility, OWA becomes the dominating technology to converge the various air interfaces into one common wireless communication platform to drive the future mobile broadband wireless industry. Meanwhile, TDD provides an optimal duplex platform for OWA system for dynamic spectrum access and open spectrum management which will become the mission-critical issue in the future mobile wireless communications.

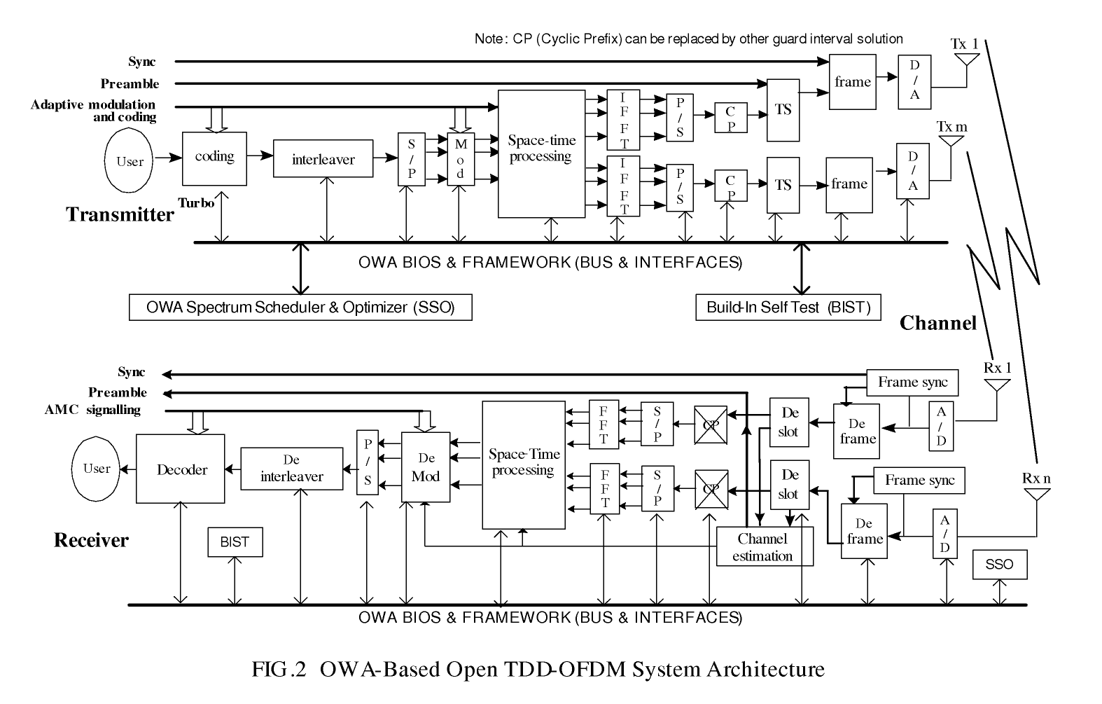

Turning now to FIG. 2, an example of TDD-OWA air interface according to one embodiment of the invention will be described in terms of TDD-OFDM system described above in connection with FIG. 1.

In order to support full convergence with other TDD air interfaces, such as TDD-SCDMA and TDD-WCDMA, this TDD-OFDM system platform is based on OWA definitions through OWA BIOS and Framework architecture wherein the whole system modules are open modules controlled by OWA BUS and OWA Interfaces. OWA BIOS and Framework are multi-layered architecture defined by the open interface parameters, so that each module is extensible and upgradeable. Same as the personal computer system defined by the open computer architecture (OCA), the OWA system is scalable, upgradeable and removable subject to the service-oriented design methodology and the service-oriented mobility architecture. Therefore, the OWA BIOS and Framework has the following functions:
1. It defines the common bus and interface architectures to enable each functional module of the system the “plug and play” feature in the OWA converged broadband wireless and mobile platform,
2. It converges and integrates the OWA system with the computer architecture platform,
3. It enables the TDD systems the capability of open and dynamic spectrum management across the various air interfaces including, but not limited to, OFDM, CDMA and TDMA (time division multiplex access),
4. It improves the wireless system performance, including power consumption and signal processing efficiency, and wireless transmission performance, including channel allocation, radio resource allocation and spectrum utilization,
5. It facilitates each TDD air interface, such as TDD-OFDM, to be independent of the OWA Service-Oriented Mobility Architecture which is the future open service delivery platform.

The OWA Spectrum Scheduler and Optimizer (SSO) is one of the most important system modules to deal with the dynamic spectrum access control and open spectrum management for the OWA TDD systems with the following important functions:
1. Validating and updating the Spectrum Sensing and Awareness Model
2. Managing the Accreditation, Trust, & Security Model
3. Updates and coordinates the real-time Digital Spectrum Map of the service area
4. Calculates the Spectrum Analytical and Allocation Model
5. Schedules and controls the Dynamic Spectrum Access for different air interfaces
6. Determines the Frequency Reuse and Frequency Recycling strategy
7. Optimizes the Cognitive Artificial Intelligence Engines for spectrum management
8. Maximizes the TDD spectrum utilization by optimizing the TDD switch point based on link asymmetry control of different locations and services
9. Tests the spectrum management performance for OWA convergence strategy

Cognitive radio is one part of the OWA systems that senses and is aware of its operational environments, including radio link budget and spectrum budget, and can dynamically, autonomously, and intelligently adjust its radio operating parameters. In order to maximize the spectrum efficiency, the cognitive radio must be constructed on the OWA platform to support future open spectrum management capability. For example, based on OWA protocols, cognitive radio can be automatically operative in a WLAN (wireless local area network) air interface whenever the user enters the WLAN service area, handover to WiMax air interface (IEEE 802.16 standard, with OFDM air interface) whenever the user leaves a WLAN area and enters a WiMax service area, and switch back to a GSM (a TDMA air interface) network if other wireless access networks are not available. In this way, wireless spectrum utilization efficiency can be maximized, and the available spectrum shared and recycled. Such dynamic spectrum management is handled by the OWA Spectrum Scheduler and Optimizer as well.

OFDM is an attractive air interface of transmitting high data-rate information over highly dispersive mobile radio channels, by dividing the serial input data stream into a number of parallel streams and transmitting these low-rate parallel streams simultaneously. OFDM converts a frequency selective cannel into a parallel collection of frequency flat sub-channels. The sub-carriers have the minimum frequency separation required to maintain orthogonality of their corresponding time domain waveforms, yet the signal spectra corresponding to different sub-carriers overlap in frequency. Hence, the available frequency bandwidth is used very efficiently. OFDM is robust against the multi-path fading as the inter-symbol interference (ISI) is completely eliminated by introducing a Cyclic Prefix (CP) or a Guard Interval (GI) of each OFDM symbol. Meanwhile, the inter-carrier interference (ICI) is also avoided which is so crucial in high data-rate transmission. Moreover, the CP enables the receiver to use fast signal processing transforms, such as a Fast Fourier Transform (FFT) or Inverse Fast Fourier Transform (IFFT) for OFDM implementation, which enables the implementation complexity dramatically reduced. In addition, OFDM offers full scalable bandwidth to support varying spectrum allocation and is easily converged with other air interfaces, including, but not limited to, SCDMA, WCDMA and TDMA, based on OWA wireless convergence platform.

In this FIG. 2, the FFT, S/P (serial to parallel conversion) and CP-removal in the Receiver subsystem, and the IFFT, P/S (parallel to serial conversion) and CP in the Transmitter subsystem are used for OFDM implementation.

The traditional OFDM cyclic prefix (CP) is actually a copy of the last portion of the data symbol appended to the front of the symbol during the guard interval. By adding a cyclic prefix, the channel can be made to behave as if the transmitted waveforms were from time minus infinite, and thus ensure orthogonality, which essentially prevents one sub-carrier from interfering with another (called inter-carrier interference, or ICI). This is accomplished because the amount of time dispersion from the channel is smaller than the duration of the cyclic prefix. After discovering the process for OFDM implementation with different applications, a variable cyclic prefix (VCP) has been proposed for some TDD-OFDM implementations and other modulations of the OWA converged systems to improve the robustness to multipath.

In OWA converged wireless networks, various air interfaces, including, but not limited to, Orthogonal Frequency Division Multiplexing (OFDM), Interleaved Frequency Division Multiplexing (IFDM) and some single carrier modulation, can be operative within a frame in unicast, multicast, simulcast and broadcast modes, therefore designing the CP length to be the same for all modes is inefficient since the single CP length is driven by the maximum of the multipath channel time delays observed over all modes of operation. Hence, the CP module in FIG. 2 is designed to be variable length across the various implementation platforms of the OWA wireless convergence infrastructure.

The TDD implementation is handled by the “TS (time slot) and Frame” modules in the Transmitter subsystem, and the “De-frame and De-slot” modules in the Receiver subsystem where the “Frame Sync” is to synchronize the TDD radio frame subject to different radio frame structures for OWA-based TDD wireless transmission technologies.

The Channel Estimation module is a required subsystem to calculate the TDD channel condition and channel performance for dynamically scheduling multiple users simultaneously transmitting on one sub-carrier and/or supporting space-time processing technologies for multi-dimensional radio transmission diversity.

The Space-Time Processing module is to use spatial multiplexing algorithms to increase data speeds and spectrum efficiency which includes, but not limited to, Multiple Input Multiple Output (MIMO) technology. Combining OFDM with MIMO can exploit diversity in both the frequency and space domains and provide exceptional system performance and transmission performance.

In order to further secure the OWA wireless convergence performance in various propagation environments of different air interfaces including, but not limited to, varied OFDM schemes, SCDMA and WCDMA schemes, adaptive MIMO, which is able to choose appropriate MIMO schemes adaptively based on different channel conditions, is considered very important for efficient radio transmission in OWA TDD systems. The utilization of adaptive MIMO technique could realize effective adjustment among different MIMO schemes as well as different deployments of transmit/receive antennas, which obtains a better trade-off between system throughput and performance. As channel estimation information and control signaling are usually needed to be fed back in adaptive MIMO application, it is convenient and simple to be implemented in TDD mode, which furnished bi-directional radio transmission in unpaired frequency band and has similar propagation characteristics for both uplink and downlink. Furthermore, adaptive MIMO technique is very suitable to be applied in OFDM systems in which each sub-carrier is flat fading and the MIMO signal processing could be performed on each sub-carrier with detection implementation substantially simplified.

The Space-Time Processing scheduler is jointly controlled by the OWA BIOS and Framework to coordinate with the overall OWA wireless convergence layer for the OWA service-oriented mobility architecture of the future broadband mobile wireless communications.

This exemplary OWA-TDD MIMO-OFDM system is an optimal RTT (radio transmission technology) candidate for the future cost-effective and spectrum-efficient high-speed wireless mobile communications to support the service-oriented multimedia mobility infrastructure. This OWA-based TDD-MIMO-OFDM RTT Portal is an open system unit wherein each module is extensible, upgradeable and removable so that it can be compatible to and easily converged with other OWA-based RTTs (or air interfaces), such as TDD-SCDMA or TDD-WCDMA, either with or without MIMO processing module for different radio applications.

The Adaptive Modulation and Coding (AMC) module, including coding, inter-leaver, S/P (serial to parallel conversion) and Mod (modulation) in the Transmitter subsystem, and DeMod (demodulation), P/S (parallel to serial conversion), De-interleaver and Decoder in the Receiver subsystem, is utilized for the open radio transmission convergence sub-layer, such as modulation, coding, equalization and segmentation, and vice verse.

The Build-In Self Test (BIST) module is an open QA&M (Quality, Administration and Maintenance) subsystem to manage the conformance and performance testing of the OWA-based TDD-OFDM system modules. The BIST test functions including, but not limited to:
1. OWA Mobility Management functions including location management, multi-dimensional handovers, node discovery and selection, mobility optimization and profile management,
2. OWA Resource Management functions including bandwidth manager, spectrum manager, resource allocation (including power allocation), channel access and scheduler, address manager and security,
3. OWA QoS Management functions including QoS manager, session manager, traffic and flow controller and packet flow scheduler,
4. OWA Radio Transmission functions including adaptive modulations and coding, space-time processing, OFDM processing and TDD framing, etc.

The BIST module shares the resources with other OWA-based RTT systems through the common OWA BIOS and Framework for the future converged service-oriented broadband wireless mobility infrastructure.

The multiple antennas are allocated flexibly based on the different space-time processing algorithms and the applications of this TDD-OFDM system, such as mobile car communication terminal, handheld mobile communications or laptop mobile computing, etc.

Based on the OWA BIOS and Framework for the future wireless convergence platform, the radio frame structure of OWA-based RTT (radio transmission technology) is an open structure which is extensive, variable and reconfigurable. This open radio frame structure is crucial to construct a truly converged broadband wireless and mobility infrastructure for supporting the service-oriented mobile multimedia information delivery platform which is independent to the specific wireless air interface standards.

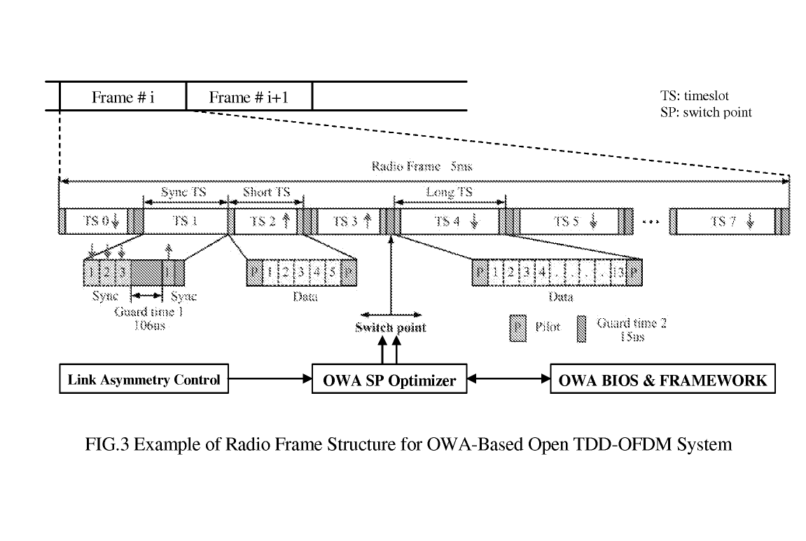

FIG. 3 is an exemplary radio frame structure for OWA-based open TDD-OFDM system, wherein the radio frame length of 5 ms (mini-second) is for example only, and can be variable to support compatibility and convergence with other TDD RTTS, such as TDD-SCDMA and TDD-WCDMA.

TS 4˜TS 7 (timeslot 4˜timeslot 7), as an example, are Long TS (timeslot) for downlink (base-station to wireless terminal) data transmission, and TS 2˜TS 3, as an example, are Short TS for uplink (wireless terminal to base-station) data transmission. TS1 is a synchronization timeslot (Sync TS) wherein three mini-slots are for downlink synchronization and one mini-slot for uplink synchronization, and the guard time (GT) in between. TS1 is a dedicated time slot used for frame synchronization and frequency synchronization in both uplink and downlink. TS0 is designed for the downlink dedicated signaling including the system information broadcast, paging and multicast, etc.

With TDD mode, both uplink and downlink transmission could be operated in any unpaired spectrum band, thus many advanced technologies such as link adaptation, joint detection could be utilized taking advantage of the reciprocal channel state information. Besides, in this OWA-based frame structure, the location of the TDD switch point (SP) could be changed according to asymmetrical service requirements and the base-station location information, etc.

The OWA Switch Point (SP) Optimizer is an important system module to manage the location of the TDD switch point which is very critical for TDD transmission in terms of radio resource management, medium access control and spectrum utilization. The OWA SP Optimizer is directed by the Link Asymmetry Control module in which the user asymmetrical service requirements, different quality of services and the different asymmetry scenarios of various base-stations located in different geographic service areas are processed. The OWA SP Optimizer is also coordinated with other OWA-based TDD networks, such as TDD-SCDMA and TDD-WCDMA, through OWA BIOS and Framework for the fully OWA-based service-oriented wireless convergence infrastructure.

As no single radio air interface or RTT (radio transmission technology) can fulfill both the broadband high-speed (especially over 20 M bps) and seamless mobility in commercial mobile wireless communications in terms of capacity, spectrum, cost and performance, this OWA-based open radio frame structure provides a robust and innovative solution to converge different RTTs or air interfaces in one single compact wireless system, either in base-station or in wireless terminal, to construct the future service-oriented broadband wireless mobility platform. Furthermore, as the OWA BIOS and Framework is compatible to personal computer system by the open computer architecture (OCA), this OWA-based TDD-OFDM system enables the fully integration and convergence with the computer system platform so that the radio terminal can be easily integrated into the laptop (mobile notebook computer) architecture or PDA (personal digital assistant) architecture, and the wireless base-station integrated into the computer workstation architecture or desktop computer (personal computer station) architecture. This is a very important technology evolution in the wireless communications because the future radio is first a Computer, then an Open Wireless Architecture (OWA) system in order to provide a truly service-oriented, rather than a standard-specific, broadband wireless information delivery infrastructure.

By combining the FIG. 1, FIG. 2 and FIG. 3 and their exemplary descriptions of the present invention, the OWA-based TDD system is reconfigurable, scalable, extensible and adaptive to various radio interfaces or RTTs, such as TDD-OFDM, TDD-SCDMA, TDD-WCDMA, etc. By further utilizing the space-time processing techniques, such as MIMO technology, these open TDD RTTs, called TDD-OWA or OWA-TDD, can be operable as the TDD-OWA-MIMO system for the future wireless and mobile communications in different radio applications, such as car mobile communications, handheld mobile communications and enterprise mobile communications, etc.

While the present disclosure and what are presently considered to be the best modes thereof have been described in a manner establishing possession by the inventor and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

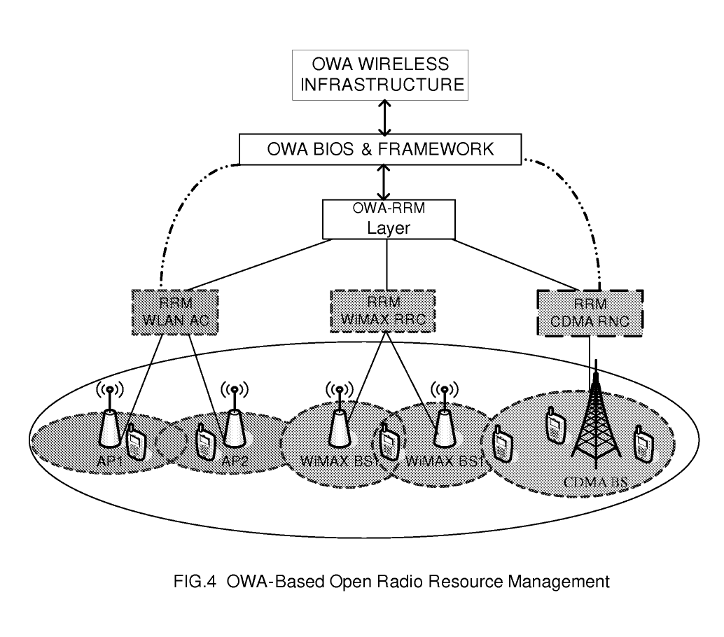

FIG. 4 illustrates an OWA-based open radio resource management (RRM) system including, but not limited to:
1. Bandwidth Manager
2. Spectrum Manager
3. Radio Resource Allocation
4. Channel Access and Scheduler
5. Address Manager
6. Transmission Security

The traditional RRM is a wireless standard-specific approach which is not appropriate for the future wireless convergence. The OWA RRM Layer provides a common and open platform to manage the different radio resources including multi-layered channel structures and frame structures of various radio air interfaces, such as WLAN (wireless local area network), WiMAX (Worldwide Interoperability for Microwave Access) and CDMA, by re-mapping their specific RRM protocols into the OWA-defined common protocol stacks which further correspond to the backbone OWA wireless infrastructure through the OWA BIOS and Framework for the construction of the future service-oriented broadband wireless information delivery platform. The OWA-RRM module is an open software subsystem which is extensible, upgradeable and removable in different radio applications. In the event that the OWA-RRM module is removed from the OWA system in consideration of system performance or transmission performance, the specific RTT-RRMs, such as WLAN-RRM, WiMAX-RRM or CDMA-RRM, can map to the OWA BIOS and Framework directly to increase the system efficiency, and reduce the implementation complexity.

The OWA RRM module is also cooperative with OWA mobility management sub-layer including, but not limited to, location management, multi-dimensional handovers (both horizontal handover and vertical handover), node discovery and selection, mobility optimization and profile management.

The OWA RRM module also supports the OWA QoS (quality of service) management sub-layer including, but not limited to, QoS manager, session manager, traffic and flow controller, packet flow scheduler and multimedia client framework.

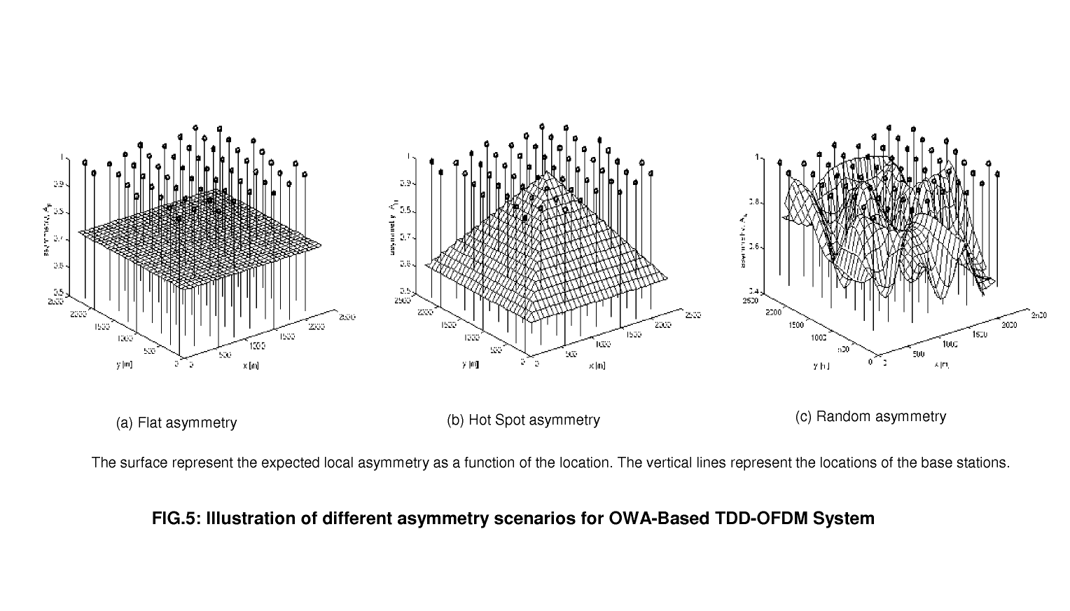

FIG. 5 illustrates the different asymmetry scenarios for the OWA-based TDD-OFDM system in the event of different base-station locations. The TDD is a very effective and efficient way for supporting asymmetrical services for the future broadband wireless multimedia services such as wireless mobile Internet services and wireless video services in which the downlink traffics are much more than the uplink traffics. However, the locations of the base-station and the service area are sometimes the critical issues in determining the TDD asymmetry in various different radio applications:
1. Flat asymmetry: In some residence area of the base station, the asymmetry traffic is very stable, wherein most of users are distributed quite evenly, and most of the services are for on-line web browsing and voice service. In this area and the corresponding base-station location, the asymmetry mode is a flat asymmetry.
2. Hot Spot asymmetry: In some hot spot areas close to special events such as Olympic Games, or dense traffics such as airports and business centers, the TDD asymmetry model will be totally different from the flat asymmetry model. However, this kind of hot-spot asymmetry is somehow stable within certain time of periods, for example, weeks, months or years.
3. Random asymmetry: This model applies to the extremely dynamic service areas where the asymmetry model changes too frequently and without rules.

This digital asymmetry map is inputted into the Link Asymmetry Control module of FIG. 3, as set forth above, to calculate the necessary parameters for the aforementioned OWA Switch-Point Optimizer of the OWA TDD systems to optimize the TDD transmission performance.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. An Architecture for OWA (open wireless architecture) based TDD-OFDM (time division duplex—orthogonal frequency division multiplex) System, said system comprising:
a) OWA BIOS (basic input/output system) and Framework providing the open and common wireless convergence platform to enable the service-oriented information delivery infrastructure,
b) OWA Spectrum Scheduler and Optimizer (SSO) managing the dynamic spectrum access control and open spectrum management for the converged OWA TDD systems,
c) OFDM modules including the FFT (fast fourier transform), serial-to-parallel conversion and cyclic prefix removal modules in the Receiver subsystem, and the IFFT (inverse fast fourier transform), parallel-to-serial conversion and cyclic prefix modules in the Transmitter subsystem,
d) TDD modules including the Time Slot and Frame modules in the Transmitter subsystem, and the De-frame, Frame Synchronization and De-Slot modules in the Receiver subsystem,
e) Space-time processing modules utilizing spatial multiplexing algorithms, including MIMO (multiple input multiple output) module to increase data speeds and spectrum efficiency,
f) Adaptive modulation and coding modules including coding, interleaver, serial-to-parallel conversion and modulation modules in the Transmitter subsystem, and demodulation, parallel-to-serial conversion, de-interleaver and decoder modules in the Receiver subsystem,
g) Build-In-Self-Test (BIST) modules managing the conformance, protocol and performance testing of the said OWA based TDD-OFDM system modules,
h) Channel Estimation module calculating the TDD channel conditions, channel parameters and channel performance for dynamically scheduling multiple users simultaneously transmitting on one sub-carrier and supporting space-time processing techniques for multi-dimensional radio transmission diversity, and
i) Other modules including Transmitter frame synchronization, Timeslot Preamble, digital-to-analog conversion, analog-to-digital conversion and multiple antennas in both transmitter and receiver.

2. A system as recited in claim 1 wherein said OWA BIOS and Framework further comprising:
a) Sub-system defining the common bus and interface architecture to enable each functional module of said TDD-OFDM system the “plug and play” feature in the OWA converged broadband wireless and mobile platform,
b) Sub-system converging and integrating the OWA systems, including said TDD-OFDM system, with the open computer architecture platform,
c) Sub-system enabling the TDD systems the capability of open and dynamic spectrum management across the various air interfaces including OFDM, CDMA (code division multiplex access) and TDMA (time division multiplex access),
d) Sub-system scheduling said Space-time processing modules, said OFDM modules, said TDD modules, said Adaptive modulation and coding modules, and said BIST modules to coordinate with the overall OWA wireless convergence layer, and
e) Sub-system separating each TDD air interface including said TDD-OFDM to be independent of the OWA service-oriented mobility architecture which is the future open service delivery platform.

3. A system as recited in claim 1 wherein said OWA Spectrum Scheduler and Optimizer further comprising:
a) Software module validating and updating the spectrum sensing and awareness model,
b) Software module managing the spectrum accreditation, trust and security model,
c) Software module updating and coordinating the real-time digital spectrum map of the service area,
d) Software module calculating the spectrum analytical and allocation model,
e) Software module scheduling and controlling the dynamic spectrum access for different air interfaces,
f) Software module determining the frequency reuse and frequency recycling strategy,
g) Software module optimizing the cognitive artificial intelligence engines for spectrum management,
h) Software module maximizing the TDD spectrum utilization by optimizing the TDD switch point based on link asymmetry control of different locations and services, and
i) Software module testing the spectrum management performance for OWA wireless convergence platform through said OWA BIOS and Framework.

4. A system as recited in claim 1 wherein said BIST modules further comprising:
a) OWA mobility management including location management, multi-dimensional handovers, node discovery and selection, mobility optimization and profile management,
b) OWA resource management including bandwidth manager, spectrum manager, resource allocation including power allocation, channel access and scheduler, address manager and transmission security,
c) OWA QoS (quality of service) management including QoS manager, session manager, traffic and flow controller, and packet flow scheduler, and
d) OWA radio transmission management including adaptive modulation and coding, space-time processing, channel estimation, frame synchronization, OFDM processing and TDD framing.

5. A system as recited in claim 1 wherein said cyclic prefix is designed to be variable length across various implementation platforms of the related OWA based TDD systems including said TDD-OFDM, TDD-IFDM (interleaved frequency division multiplex) and TDD single carrier modulation.

6. A system as recited in claim 1 wherein said Frame Synchronization is to synchronize the TDD radio frame subject to different radio frame structures of OWA based TDD wireless transmission technologies including TDD-OFDMA (OFDM access), TDD-SCDMA (synchronized CDMA) and TDD-WCDMA (wideband CDMA).

7. A system as recited in claim 1 wherein said OFDM modules enable dynamically scheduling multiple users simultaneously transmitting and receiving on one subcarrier.

8. A system as recited in claim 1 wherein said Space-time processing modules include adaptive MIMO (multiple input multiple output) capable of choosing appropriate MIMO schemes adaptively based on different channel conditions of different air interfaces including said TDD-OFDM and its varied schemes, said TDD-SCDMA scheme and said TDD-WCDMA scheme, to optimize the OWA wireless convergence performance in various propagation environments.

9. A system as recited in claim 8 wherein said adaptive MIMO works with said TDD-OFDM system in which each subcarrier has flat fading and said adaptive MIMO signal processing could be done on each said subcarrier with detection complexity substantially simplified.

10. Systems as recited in claim 1 wherein said TDD modules, said OFDM modules and said MIMO module construct the TDD-MIMO-OFDM system based on said OWA BIOS and Framework platform for the future cost-effective and spectrum-efficient high-speed broadband wireless mobile communications to support the service-oriented wireless multimedia infrastructure.

11. A system as recited in claim 10 wherein said TDD-MIMO-OFDM is an open system in which each functional module is extensible, scalable, upgradeable and removable so that it can be compatible to and easily converged with other OWA based air interfaces including said TDD-SCDMA and said TDD-WCDMA, either with or without said MIMO processing module for different radio applications.

12. An Open Radio Frame Structure for OWA based TDD-OFDM System, said system comprising:
a) Said OWA BIOS and Framework platform providing the open and common wireless convergence layer independent of the specific radio air interfaces,
b) OWA Switch Point Optimizer managing the location of the TDD transmitting/receiving switch point critical for TDD transmissions including radio resource management, medium access control, transmission convergence and spectrum utilization,
c) Link Asymmetry Control utilizing the user asymmetrical service requirements, different quality of services and different asymmetry scenarios of various base-stations located in different geographic service areas to support said OWA Switch Point Optimizer,
d) Downlink (base-station to wireless terminal) Data Transmission Timeslots,
e) Uplink (wireless terminal to base-station) Data Transmission Timeslots,
f) Downlink and Uplink transmission switch point,
g) Synchronization Timeslot comprising downlink synchronization, uplink synchronization and the guard time between them, used for frame synchronization and frequency synchronization in both downlink and uplink,
h) Downlink dedicated Signaling Timeslot including system information broadcast, paging and multicast,
i) Guard Times between said Downlink data transmission timeslots and said Uplink data transmission timeslots, and
j) TDD Radio Frame comprising said downlink data transmission timeslots, said uplink data transmission timeslots, said synchronization timeslot, said downlink dedicated signaling timeslot and said guard times.

13. A system as recited in claim 12 wherein said OWA Switch Point Optimizer operates with other OWA based TDD systems including said TDD-SCDMA and said TDD-WCDMA through said OWA BIOS and Framework for the OWA-based service oriented wireless convergence platform implementation.

14. A system as recited in claim 12 wherein said Radio Frame has variable frame length to support compatibility and convergence with other OWA based TDD air interfaces including said TDD-SCDMA and said TDD-WCDMA.

15. A system as recited in claim 12 wherein said Radio Frame is an open structure which is extensible, scalable and reconfigurable and utilized to construct a truly converged broadband wireless and mobility platform for supporting the service-oriented mobile multimedia information delivery infrastructure.

16. A TDD-OWA (time division duplex—open wireless architecture) Converged System Architecture, said system comprising:
a) TDD-OWA Open Spectrum Management responsible for open spectrum allocation and dynamic spectrum access control,
b) TDD-OWA Radio Resource Management providing compatibility, comparability, conformance and optimization among different OWA-based TDD air interfaces,
c) TDD-OWA BIOS and Framework providing the open and common wireless convergence layer independent of the specific radio air interfaces,
d) Air-Interface system modules of said TDD-OFDMA, said TDD-SCDMA and said TDD-WCDMA based on said TDD-OWA BIOS and Framework,
e) TDD Multi-Users Scheduler comprising capability of managing different multiple users to access the multi-layered channels provided by said TDD-OFDMA, said TDD-SCDMA and said TDD-WCDMA air interfaces, and
f) OWA Service-Oriented Mobility Architecture managing the open service delivery platform independent of the specific wireless air interfaces and managing high-layer software architectures including multimedia framework, mobile operating systems, mobile applications, service convergence and security sublayer.

17. A system as recited in claim 16 wherein said OWA Radio Resource Management (RRM) provides a common and open platform to manage the different radio resources including multi-layered channel structures and frame structures of various radio interfaces including WLAN (wireless local area network based on said OFDM or said TDMA), WiMAX (worldwide interoperability for microwave access based on said OFDM) and said CDMA by re-mapping their specific RRM protocols into the OWA-based common protocol stacks corresponding to the backbone OWA wireless convergence infrastructure through said OWA BIOS and Framework for the construction of the future service-oriented broadband wireless information delivery platform.

18. A system as recited in claim 12 wherein said Link Asymmetry Control module further includes a digital asymmetry map by locations of the base-stations and the service areas in determining the TDD asymmetry in different radio applications of flat distribution asymmetry, hot-spot distribution asymmetry and random distribution asymmetry to calculate the necessary parameters for said OWA Switch-Point Optimizer of said TDD-OFDM system and optimize the TDD transmission performance.

19. A system as recited in claim 1 wherein said OWA BIOS and Framework is compatible to the personal computer system by open computer architecture in providing said TDD-OFDM system of full integration and convergence capability with the computer system platform so that the radio terminal of said TDD-OFDM can be easily integrated into the notebook computer architecture or personal digital assistant architecture, and the wireless base-station of said TDD-OFDM integrated into the computer workstation architecture or desktop computer architecture for the future totally convergence of computer and wireless communications.

20. A system as recited in claim 16 wherein said TDD-OFDMA system can provide cost-effective and spectrum-efficient broadband high-speed wireless transmissions as well as seamless mobility functions by converging with said TDD-SCDMA or said TDD-WCDMA system based on the OWA wireless convergence platform.
